(19) United States
(12) Patent Application Publication
(10) Pub. No.: US 2007/0245335 A1
(43) Pub. Date: Oct. 18, 2007

(54) Software management apparatus and software management method

(75) Inventors: Eiji Minagawa, Kawasaki (JP); Kayo Endou, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/589,843

(22) Filed: Oct. 31, 2006

(30) Foreign Application Priority Data
Mar. 28, 2006 (JP) 2006-87313

(51) Int. Cl. G06F 9/44

(52) U.S. Cl. 717/168

(57) ABSTRACT

A software management apparatus includes a mail receiving unit receiving an email in which update information as information on an update of the updated software is set, a mail decoding unit decoding the email received by the mail receiving unit and extracting the update information, and a downloading unit downloading the updated software based on the update information extracted by the mail decoding unit.

### CROSS-REFERENCE TO RELATED APPLICATIONS

This application claims the conventional priority based on Japanese Application No. 2006-087313, filed on Mar. 28, 2006, the disclosures of which are incorporated herein by reference.

### BACKGROUND OF THE INVENTION

1. Field of the Invention

The present invention relates to a software management apparatus and a software management method and more particularly to a software management apparatus and a software management method that automatically download updated software.

2. Description of the Related Art

When a user of software (hereinafter referred to as “user”) prefers to obtain an updated software, a procedure as described below is typically required. The software refers to various programs, databases or the like, for example. An update of the software refers to a version upgrade (revision of a version) of the software, addition (appendage) of a new program or the like, for example.

First, the user is notified by a provider of the software (hereinafter referred to as “vendor”) that the software is upgraded or changed. The notification is performed, for example, with a postal mail, a telephone call, an email and the like from the vendor. For example, the user determines whether or not it is necessary to download the updated software, by browsing information on the update of the software which is placed on a web site of the vendor (a homepage of the vendor or a dedicated page for downloading the software). When it is necessary to download the software, the user downloads the updated software, for example, for each piece of software, for each OS (Operating System) or for each version number of the software.

There is a technique in a system having a minilab (a shop having a relatively small photo processing facility) placing data related to the change in a software and its setup software in a server provided in a center and allowing an operator of the minilab to install the data related to the change in the software and its setup software when the software related to the photo processing facility is changed (refer to Japanese Patent Laid-Open No. 2000-305187).

According to a conventional software obtaining method, since the user has to access the web site of the vendor to confirm whether the software notified by a vendor apparatus is updated, an effort by the user is large.

Moreover, according to a technique described in Japanese Patent Laid-Open No. 2000-305187, it is necessary to receive the data related to the change in the software and its setup software, and make the data related to the change in the software available with the setup software, by performing operations by the operator of the minilab in response to information related to the change in the software which is sent from the center. Therefore, with the technique described in Japanese Patent Laid-Open No. 2000-305187, it is not possible to automatically obtain the changed software, and also an effort by the operator is large.

### SUMMARY OF THE INVENTION

It is an object of the present invention to provide a software management apparatus for automatically downloading updated software by decoding an email in which information on an update of the software is set.

It is another object of the present invention to provide a software management method for automatically downloading updated software by decoding an email in which information on an update of the software is set.

It is still another object of the present invention to provide a computer readable storage medium recording a software management program for automatically downloading updated software by decoding an email in which information on an update of the software is set.

The software management apparatus of the present invention comprises a mail receiving unit receiving an email in which update information as information on an update of updated software is set, a mail decoding unit decoding the email received by the mail receiving unit and extracting the update information, and a downloading unit downloading the updated software based on the update information extracted by the mail decoding unit.

Preferably, the software management apparatus further comprises a download management unit creating management information as data for managing the software downloaded by the downloading unit.

The software management method for managing software of the present invention comprises receiving an email in which update information as information on an update of updated software is set, decoding the received email and extracting the update information, and downloading the updated software based on the extracted update information.

The computer readable storage medium recording a software management program of the present invention is the computer readable storage medium recording a software management program for managing software. The program causes a computer to execute receiving an email in which update information as information on an update of updated software is set, decoding the received email and extracting the update information, and downloading the updated software based on the extracted update information.

According to the software management apparatus, the software management method and the computer readable storage medium recording a software management program of the present invention, the email in which the update information is set is decoded and the update information is extracted, and based on the update information, the updated software is downloaded. Thereby, it is possible to automatically download the updated software, following the decoding of the email in which the update information is set. Therefore, it is not necessary for the user to access the web site of the vendor to confirm whether or not the software notified by a vendor apparatus sending updated software to the software managing apparatus is updated, and it is possible to eliminate an effort by the user (operator) for downloading the software.

Moreover, according to the software management apparatus of the present invention, the management information on the downloaded software is created. Thereby, it is possible to manage the downloaded software without a user intervention.

### BRIEF DESCRIPTION OF THE DRAWINGS

FIG. 1 is a diagram showing an example of a system structure of the present invention.

FIG. 2 is a diagram showing an example of an email received by a software management apparatus from a vendor apparatus.

FIG. 3 is a diagram showing setting contents of an environment setting file.

FIG. 4 is a diagram showing an example of a data structure of a download data DB.

FIG. 5 is a diagram showing an example of a data structure of a download management DB.

FIG. 6 is a diagram showing an example of a process flow of registering updated software by the vendor apparatus.

FIG. 7 is a diagram showing an example of a process flow of downloading software by the software management apparatus.

### DETAILED DESCRIPTION OF THE PREFERRED EMBODIMENTS

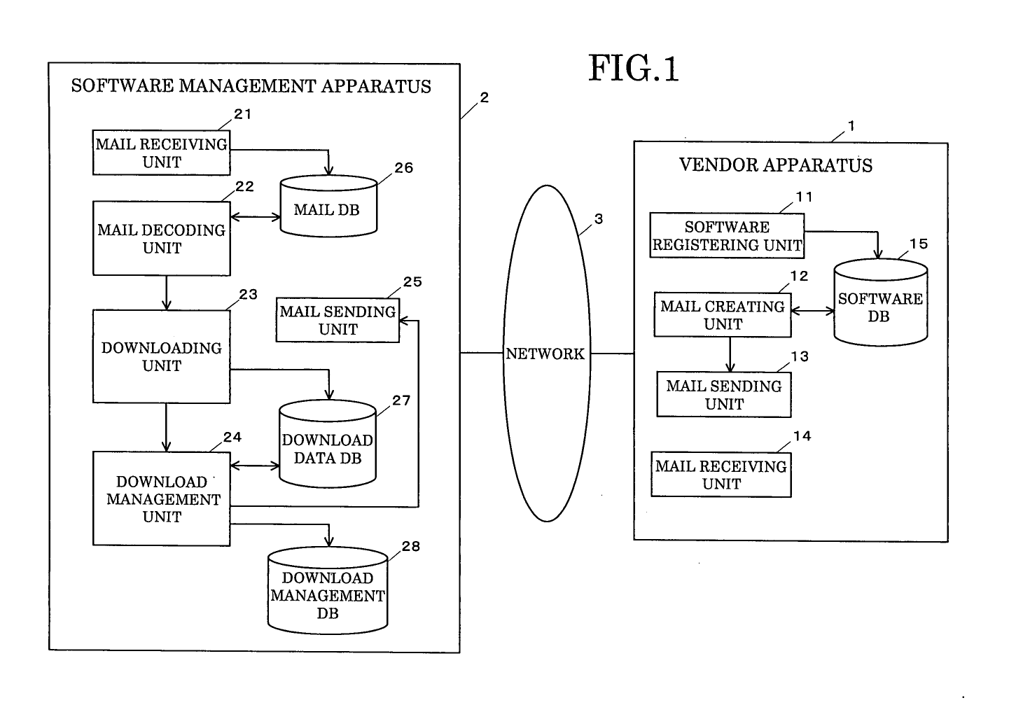

FIG. 1 is a diagram showing a structure of a software management system according to an embodiment of the present invention. The software management system includes a vendor apparatus 1, and a software management apparatus 2 which is connected to the vendor apparatus 1 via a network 3. The network 3 includes the Internet and the like, for example. The vendor apparatus 1 is a computer provided at a vendor who is a provider of software, and sends updated software to the software management apparatus 2. The software management apparatus 2 is a computer provided at a user of the software, and downloads the updated software from the vendor apparatus 1 and manages the software.

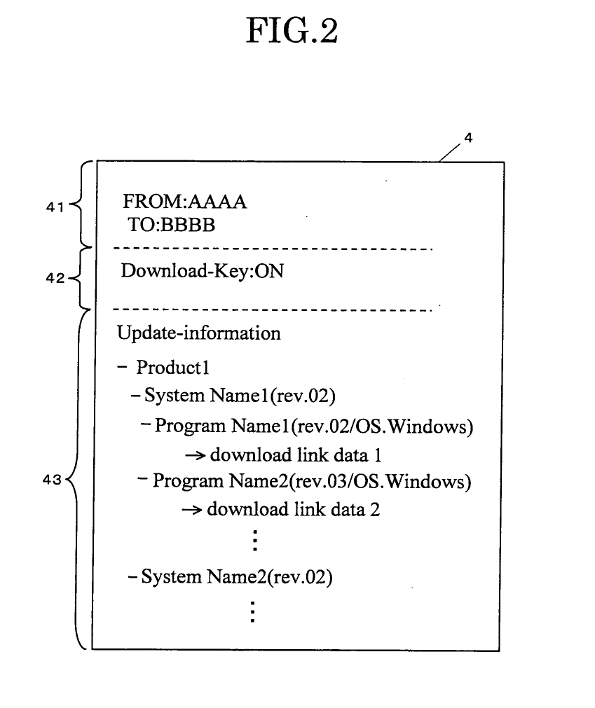

The vendor apparatus 1 registers the updated software in a software database (DB) 15, sets information on the update of the software (hereinafter referred to as “update information”) in an email 4 (refer to FIG. 2), and sends the email 4 to the software management apparatus 2 via the network 3. For this purpose, the vendor apparatus 1 includes a software registering unit 11, a mail creating unit 12, a mail sending unit 13, a mail receiving unit 14, and the software DB 15. These respective units 11 to 15 provided in the vendor apparatus 1 are realized with a CPU, a program executed on the CPU, and other well-known hardware (this is also applicable to the software management apparatus 2).

The software registering unit 11 creates (a file of) the updated software according to an instruction inputted by a software developer via an input device (not shown) at the vendor, and registers the updated software in the software DB (memory unit) 15. Therefore, the software DB 15 stores (the file of) the software registered by the software registering unit 11. The mail creating unit 12 sets update information 43 (see FIG. 2) on the updated software in the email 4 according to the input by a developer. In other words, the mail creating unit 12 creates the email 4 in which the update information is set. The mail sending unit 13 sends the email 4 in which the update information 43 is set to the software management apparatus 2 via the network 3 according to the input by the developer. The mail receiving unit 14 receives an email for notifying a result of downloading the software, from the software management apparatus 2.

The software management apparatus 2 receives the email 4 in which the update information is set from the vendor apparatus 1, and triggered by receiving the email 4 (at a time when the software management apparatus 2 receives the email 4), downloads the software. In other words, the software management apparatus 2 decodes (analyzes) the received email 4 to extract the update information, and downloads the software based on the update information. For this purpose, the software management apparatus 2 includes a mail receiving unit 21, a mail decoding unit 22, a downloading unit 23, a download management unit 24, a mail sending unit 25, a mail database (DB) 26, a download data database (DB) 27, and a download management database (DB) 28.

The mail receiving unit 21 receives the email 4 in which the update information 43 is set from the vendor apparatus 1 via the network 3, and stores the email 4 in the mail DB 26. Triggered by receiving the email 4, the mail decoding unit 22 decodes the email 4 stored in the mail DB 26 to extract the update information 43 from the email 4, and sends the update information 43 to the downloading unit 23.

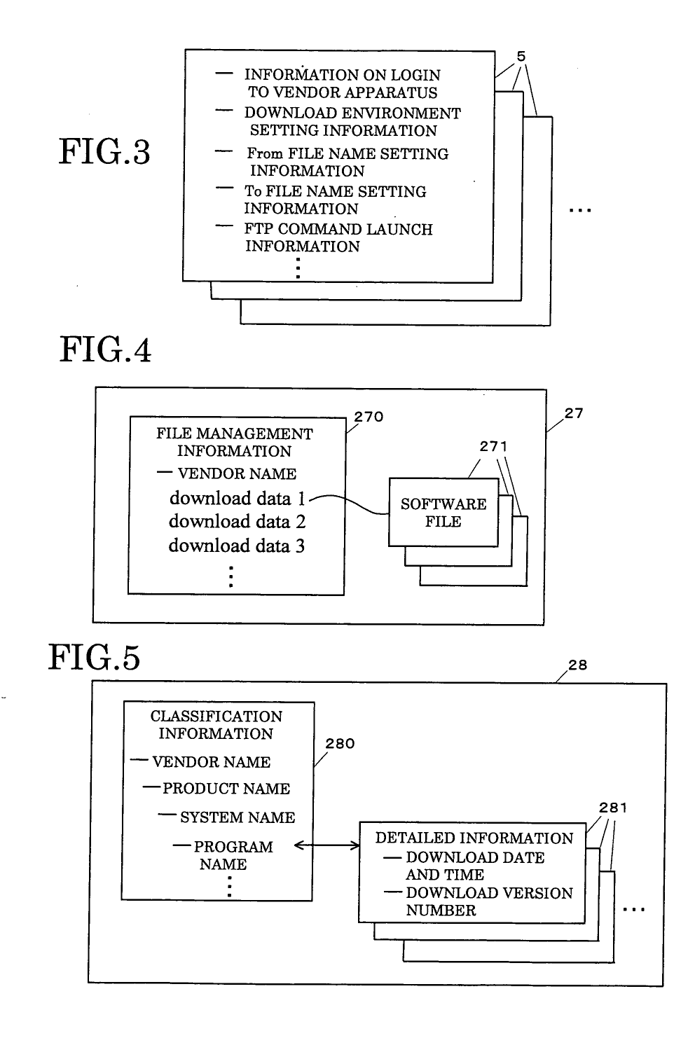

Based on the extracted update information 43, the downloading unit 23 downloads the updated software from the vendor apparatus 1 via the network 3, and stores the updated software in the download data DB 27. Prior to the download of the software, the downloading unit 23 creates an environment setting file 5 (refer to FIG. 3) required for executing the download of the software for each piece of software that is a download target. For this purpose, the downloading unit 23 includes a form of the environment setting file 5 previously. After the downloading unit 23 sets necessary items in the environment setting file 5, the downloading unit 23 downloads the software from the software DB 15 in the vendor apparatus 1 according to the environment setting file 5 with a File Transfer Protocol (FTP). In other words, the downloading unit 23 executes the download according to the environment setting file 5 created based on the update information 43.

The download management unit 24 manages (the file of) the software stored in the download data DB 27. Moreover, the download management unit 24 creates management information as information for managing the software stored in the download data DB 27, and stores the management information in the download management DB 28. Furthermore, the download management unit 24 sends the result of the download to the mail sending unit 25. Based on the result of the download, after the download is executed, the mail sending unit 25 sends the email for notifying the download result to the vendor apparatus 1. Thereby, the vendor apparatus 1 is notified whether or not the software is correctly downloaded in the software management apparatus 2.

FIG. 2 shows an example of a structure of the email 4 sent by the vendor apparatus 1. As shown in FIG. 2, the email 4 has a predetermined format. The format (form) is previously provided in the mail creating unit 12 as a tool for assisting the creation of the email 4. In other words, the email 4 includes predetermined information described at a predetermined position, and includes at least the update information as the predetermined information. Specifically, the email 4 has the structure in which a header 41, a download key 42 and the update information 43 are described in this order. The developer at the vendor sets (inputs) the predetermined information in the form of the email 4.

The header 41 has a structure in which sender information and sending destination information are described in this order. The sender information “FROM:AAAA” is an email address of a sender of the email 4 (the vendor apparatus 1). In this example, the email address of the sender is AAAA. The sending destination information “TO:BBBB” is an email address of a sending destination of the email 4 (the software management apparatus 2). In this example, the email address of the sending destination is BBBB. The email address of the sending destination is previously registered in the vendor apparatus 1 as the email address of the software management apparatus 2 which prefers to receive the email 4, and is selected and used by the developer. Thereby, the user can receive the email 4 including the update information 43.

“Download-Key” is the download key 42. The download key 42 is a key (information) indicating whether or not the software related to the update information 43 is set to the download target. The software related to the update information 43 is the software for which it is notified with the update information 43 that the update is performed. For example, when an installation personnel (the user) of the software management apparatus 2 prefers to download the software, the download key 42 is set to ON. The download key 42 (ON of the download key 42) is previously registered in the vendor apparatus 1, indicates that the software management apparatus 2 prefers to download the software, and is used by the developer. Thereby, the user can download the updated software automatically.

When the download key 42 is ON or OFF, the software is set to the download target, or is not set to the download target, respectively. Thereby, it becomes unnecessary for the user to be conscious of whether or not the software related to the update information 43 included in the email 4 is the download target. Moreover, it is possible for the user to select to prefer only to receive the email 4 and not to prefer to download the software related to the update information 43 included in the email 4.

“Update-information” is a key (mark) indicating that the following description is the update information 43. The update information 43 includes at least “program name” indicating the updated software, and information on a link (link information) to the updated software. In this example, the update information 43 includes a product name, a system name, the program name and the link information.

“Product 1” is the product name. The product name is a name of a product of the software related to the update information 43. “System Name1(rev.02)” is the system name. The system name is a name of each product configuring a product related to the product name. The system name includes additional information. The additional information “rev.02” is version number information on the product having the system name, and for example, indicates that the version number is the second version. It should be noted that the name of a product in which the product related to the product name is integrated may be the system name.

“Program Name1(rev.02/OS.Windows)” and “Program Name2(rev.03/OS.Windows)” are the program names. The program name is a name of the software (the program or the database) related to the update information 43. The software having the program name is the updated software. Therefore, the program name is a unit of the download. The program name includes first and second additional information. For example, the first additional information “rev.02” is information on the version number of the software having the program name, and for example, indicates that the version number of the software is the second version. Moreover, the second additional information “OS.Windows” is OS information indicating an OS to which the software having the program name corresponds, and for example, indicates that the OS is the Windows (registered trademark).

In this example, one or more of program names of the software that belongs to the product related to each system name are described. In this example, since the software having the program names “Program Name1” and “Program Name2” which belong to the product having the system name “System Name1” is uploaded, these program names are described beneath “System Name1”. Therefore, in this case, based on one email 4 (or the update information 43), a plurality of software are downloaded.

Moreover, in this example, the version number of the product having a system name and the version number of the software which belongs to the product having the system name are changed in conjunction with each other. For example, when the version number of the software having the program name “Program Name1” is changed, the version number of the product having the system name “System Name1” is also changed similarly, and the update information 43 in which the changed version number of the product is described is set in the email 4.

“Download link data 1” is the link information. The link information is link information related to the update information 43. As described above, since the vendor apparatus 1 stores the updated software in the software DB 15, the link information is address information indicating an address at which the software is stored in the software DB 15. For example, since “download link data 1” is described beneath the program name “Program Name1”, “download link data 1” denotes the address at which the software having the program name is stored in the software DB 15.

When the email 4 is received, as described above, the mail decoding unit 22 decodes this email 4 and extracts the update information 43 by retrieving the description below the “Update-information”. Prior to this decoding, the mail decoding unit 22 confirms whether the download key 42 in the email 4 is ON. A result of confirming the update information 43 and the download key 42 is sent to the downloading unit 23. In response to this, when the download key 42 is ON, the downloading unit 23 creates the environment setting file 5 based on the update information 43 for downloading the software.

FIG. 3 shows an example of the environment setting file 5. As shown in FIG. 3, the downloading unit 23 sets “Information on login to vendor apparatus”, “Download environment setting information”, “From file name setting information”, “To file name setting information” and “FTP command launch information” in the environment setting file 5. At this time, in the example of FIG. 2, there are two program names “Program Name1” and “Program Name2”. In other words, since there are two pieces of software to be downloaded, two environment setting files 5 are created. In other words, the environment setting file 5 is created for each program name in the update information 43 (for each piece of software to be downloaded).

“Information on login to vendor apparatus” includes login information for logging in the vendor apparatus 1. Specifically, “Information on login to vendor apparatus” includes a password or an ID. The login information is previously defined between the software management apparatus 2 and the vendor apparatus 1. The downloading unit 23 includes the login information previously, and sets the login information at “Information on login to vendor apparatus” in the environment setting file 5.

“Download environment setting information” includes the link information with respect to the updated software. The downloading unit 23 extracts the link information from the update information 43. Specifically, the downloading unit 23 extracts, for example, “download link data 1” from the update information 43, and sets the link information (“download link data 1”) at “Download environment setting information” in the environment setting file 5.

“From file name setting information” includes file information on a file in which the updated software is stored (From file information). The From file information is previously defined between the software management apparatus 2 and the vendor apparatus 1. The downloading unit 23 includes the From file information previously, and sets the From file information at “From file name setting information” in the environment setting file 5. The From file information is equal to a file name of the software stored at an address of a destination of the link indicated by the link information in the update information 43. In other words, the file name of the software that is the download target is previously defined, and the updated software is stored in the file having the file name in the software DB 15.

“To file name setting information” includes file information on a file in which the downloaded software should be stored (To file information). The To file information is previously defined by the software management apparatus 2. The downloading unit 23 includes the To file information previously, and sets the To file information at “To file name setting information” in the environment setting file 5. In other words, the file name in which the downloaded software is stored is previously defined, and the downloaded software is stored in the file having the file name in the download data DB 27.

“FTP command launch information” includes launch information for launching an FTP command. This launch information can be previously known. The downloading unit 23 includes the launch information previously, and sets the launch information at “FTP command launch information” in the environment setting file 5.

The downloading unit 23 downloads the updated software according to the environment setting file 5 created as described above. In other words, the downloading unit 23 logins the vendor apparatus 1 using “Information on login to vendor apparatus”, downloads the file of the file name indicated by “From file name setting information” stored at the address of the destination of the link indicated by “Download environment setting information” with the FTP launched with “FTP command launch information”, and stores the file in the file indicated by “To file name setting information”, in the download data DB 27.

FIG. 4 shows an example of a structure of the download data DB 27. In this example, the downloading unit 23 stores each downloaded software (download data) in a software file 271 indicated by “To file name setting information” in the corresponding environment setting file 5. In response to this, the download management unit 24 generates file management information 270 and stores the file management information in the download data DB 27. It should be noted that the downloading unit 23 may generate the file management information 270.

As shown in FIG. 4, the file management information 270 is generated for each email 4 (or update information 43), and is information for managing the software file 271 in which the downloaded software is stored. The file management information 270 includes a vendor name and one or more of file names. The vendor name is a name of the vendor related to the vendor apparatus 1, and is generated based on “From:AAAA” in the email 4, for example. “Download data 1” and so on is a file name. The file name is a file name of the corresponding software file 271, and is generated by using the file name indicated by “To file name setting information”.

Practically, each file name includes the link information with respect to the corresponding software file 271 (for example, a pointer indicating the software file 271). Thereby, as shown in FIG. 4, each one of the file names in the file management information 270 is associated with the software file 271.

FIG. 5 shows an example of one piece of the management information stored in the download management DB 28. In this example, when the downloaded software is stored in the software file 271, in response to this, the download management unit 24 generates the management information based on the update information 43, and stores the management information in the download management DB 28. The management information is generated for each email 4 (or update information 43). The management information is information for managing (a history of) the download of the software.

As shown in FIG. 5, one piece of the management information includes classification information 280 and detailed information 281. As shown in FIG. 5, the classification information 280 is information in which the downloaded software is classified by using “Vendor name”, “Product name”, “System name” and “Program name”. For example, “Vendor name” is generated based on “From:AAAA” in the email 4. “Product name”, “System name” and “Program name” are generated from the product name, the system name and the program name in the update information 43, respectively.

The detailed information 281 is generated for each “Program name” in the classification information 280, and includes “Download date and time” and “Download version number”. “Download date and time” includes date and time at which the software is downloaded. “Download version number” includes the version number of the system of the product to which the downloaded software belongs, and the version number of the downloaded software. The download management unit 24 generates “Download date and time”, based on a timer (not shown in a diagram) incorporated in the software management apparatus 2. Moreover, the download management unit 24 generates “Download version number”, based on the version number of the system name and the version number of the program name in the update information 43, as “Download version number”.

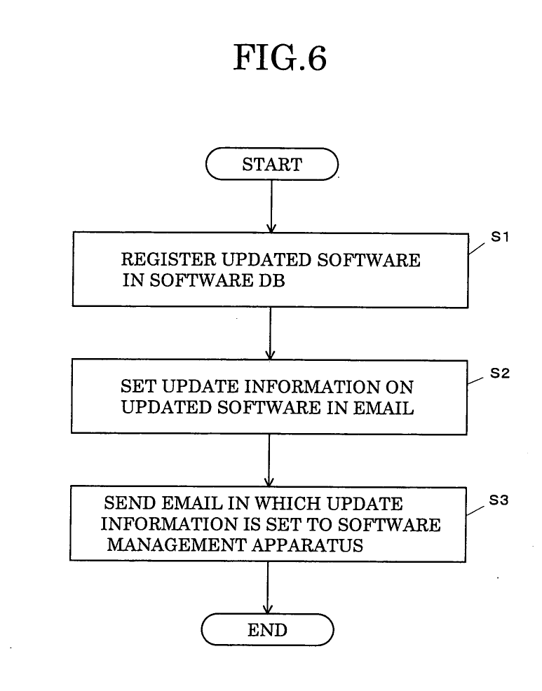

FIG. 6 is a diagram showing an example of a process flow of registering the updated software in the vendor apparatus 1.

At the vendor, the developer of the software registers the software updated with a software development apparatus (not shown) at a predetermined address in the software DB 15 using the software registering unit 11 of the vendor apparatus 1 (step S1). Next, using the mail creating unit 12, the developer creates the email 4 in which the update information 43 related to the updated software is set (step S2). After that, using the mail sending unit 13, the developer sends the email 4 in which the update information 43 is set to the software management apparatus 2 previously registered (step S3).

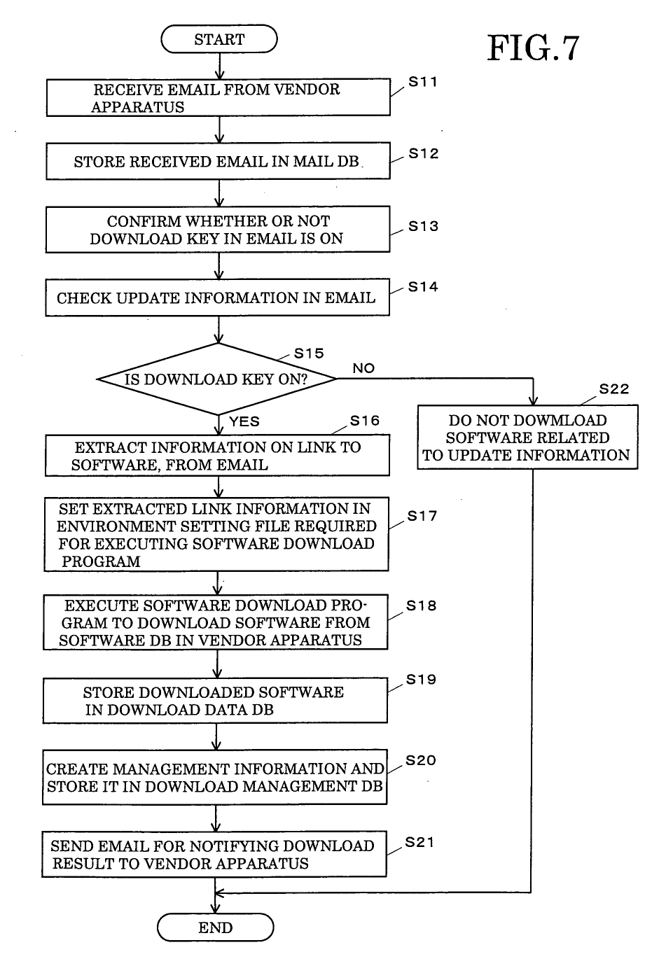

FIG. 7 is a diagram showing an example of a process flow of downloading the software by the software management apparatus 2.

The mail receiving unit 21 in the software management apparatus 2 receives the email 4 from the vendor apparatus 1 (step S11), and stores the received email 4 in the mail DB 26 (step S12). Triggered by this, the mail decoding unit 22 confirms whether the download key 42 in the email 4 is ON or OFF (step S13), and checks whether or not the update information 43 in the email 4 is normal (for example, whether or not the link information is missing) (step S14). When the update information 43 is not normal, for example, the mail decoding unit 22 requests the vendor apparatus 1 to send the email 4 again.

After that, the downloading unit 23 determines whether the download key 42 is ON based on a result of the process of confirming the download key 42 at the step S13 (step S15). When the download key 42 is ON, the downloading unit 23 extracts the link information from the email 4 (step S16), and sets the link information in the environment setting file 5(step S17). At this time, the environment setting file 5 is created for each “Program name” in the update information 43.

After that, the downloading unit 23 downloads the software from the software DB 15 in the vendor apparatus 1 (step S18). At this time, the downloading unit 23 downloads the software for each “Program name” in the update information 43. The downloading unit 23 stores the downloaded software in the download data DB 27 (step S19). At this time, the download management unit 24 creates the file management information and stores the file management information in the download data DB 27.

Next, the download management unit 24 creates the management information and stores the management information in the download management DB 28 (step S20). On the other hand, the mail sending unit 25 sends the email for notifying the download result to the vendor apparatus 1 (step S21), and terminates the process.

At the step S15, when the download key 42 is not ON, the downloading unit 23 does not download the software related to the update information 43 (step S22), omits execution of the steps S16 to S21 and terminates the process.

As described above, although the present invention is described based on its embodiment, various variations of the present invention are possible within the scope of the present invention.

For example, the structure of the software management system of the present invention is not limited to the structure shown in FIG. 1. For example, one software management apparatus 2 may be connected to a plurality of vendor apparatuses 1 via the network 3. Moreover, for example, a plurality of software management apparatuses 2 may be connected to one vendor apparatuses 1 via the network 3.

Moreover, the software management apparatus 2 may create the email 4 in which the update information 43 on the software stored in the download data DB 27 is set, and may send this email 4 to other software management apparatus 2 (not shown) via the network. In this case, the software management apparatus 2 changes the link information in the update information 43 to a file storage position in the download data DB 27. Thereby, the other software management apparatus 2 may perform a process similar to the process flow of downloading shown in FIG. 7, to download the software. Furthermore, the process similar to the process flow of downloading may be repeated hierarchically. Thereby, for example in an intranet of an identical company, it is possible to transfer the updated software to a lower computer (or server) without an administrator intervention.

A program for realizing the present invention may be stored in a computer readable storage medium, for example, a semiconductor memory, a hard disk, a CD-ROM, a DVD and so on, and is recorded and provided in these storage media, or is provided by sending and receiving the program using the network via a communication interface.

As described above, according to the present invention, it is possible to automatically download the updated software, triggered by receiving the email in which the update information is set. Therefore, it is possible to eliminate an effort by the user for downloading the software. As a result, for example, in a company and so on which purchases and uses many pieces of software, it is possible to eliminate a trouble of having to monitor the update of the software by an administrator who manages the update of the software, and thereby to reduce an effort by the administrator and reduce an administration cost.

What is claimed is:

1. A software management apparatus, comprising:
a mail receiving unit receiving an email in which update information as information on an update of updated software is set;
a mail decoding unit decoding the email received by the mail receiving unit and extracting the update information; and
a downloading unit downloading the updated software based on the update information extracted by the mail decoding unit.

2. The software management apparatus according to claim 1, further comprising:
a download management unit creating management information as data for managing the software downloaded by the downloading unit.

3. The software management apparatus according to claim 2, wherein the management information includes at least information on date and time at which the software is downloaded by the downloading unit and information on a version number of the downloaded software.

4. The software management apparatus according to claim 1, wherein the update information includes at least information on a version number of the downloaded software and information on a link to the updated software.

5. The software management apparatus according to claim 1,
wherein the mail decoding unit extracts the update information, triggered by receiving the email by the mail receiving unit, and
wherein the downloading unit downloads the updated software when the mail decoding unit extracts the update information.

6. The software management apparatus according to claim 1,
wherein the mail decoding unit confirms whether a download key as a key indicating whether or not the software is a download target in the email is ON, and
wherein, when the download key is ON, the downloading unit downloads the software.

7. A software management method for managing software, comprising:
receiving an email in which update information as information on an update of updated software is set;
decoding the received email and extracting the update information; and
downloading the updated software based on the extracted update information.

8. A computer readable storage medium recording a software management program for managing software, the program causing a computer to execute:
receiving an email in which update information, which is information on an update of updated software is set;
decoding the received email and extracting the update information; and downloading the updated software based on the extracted update information.
